(19) United States
(12) Patent Application Publication
(10) Pub. No.: US 2006/0145935 A1
(43) Pub. Date: Jul. 6, 2006

(54) Mobile communication device

(75) Inventor: I-Ming Lo, Taipei City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/325,778

(22) Filed: Jan. 4, 2006

(30) Foreign Application Priority Data
Jan. 5, 2005 (TW) TW94100236

(51) Int. Cl. H01Q 1/24

(52) U.S. Cl. 343/702; 343/906

(57) ABSTRACT

A mobile communication device is disclosed. A housing includes a receiving portion. An antenna is detachably disposed in the receiving portion and includes a first buckling portion. A rotating fastener is pivoted to the housing and includes a second buckling portion movably engaging the first buckling portion to fix the antenna to the housing.

### BACKGROUND

The invention relates to a mobile communication device, and in particular to a mobile communication device with an antenna detachably disposed in a housing by way of a rotating fastener.

Referring to FIG. 1A, a conventional mobile communication device comprises a main body 11 and an antenna 12. A pattern 121 is often formed on the antenna 12, as shown in FIG. 1A, presenting an aesthetically pleasing appearance for the mobile communication device. As shown in FIG. 1B, a conventional antenna 12′ comprises a connecting portion 122 inserted into a corresponding recess (not shown) of the main body 11, by which the main body 11 is connected to the antenna 12′. Accordingly, the antenna 12′ can be easily replaced. Nevertheless, as the connecting portion 122 is rotatable in the recess, the pattern 121 on the antenna 12′ cannot be precisely maintained on the front of the mobile communication device. As shown in FIG. 1C, another conventional antenna 12″ comprises an engaging hook 123 inserted into a corresponding engaging groove (not shown) of the main body 11, by which the main body 11 is fixed to the antenna 12″. Accordingly, the antenna 12′ with a specific profile can be easily positioned in the mobile communication device. The antenna 12″, however, cannot be replaced easily.

### SUMMARY

Accordingly, the present invention provides a mobile communication device capable of easy positioning and replacement of an antenna. In an exemplary embodiment, the mobile communication device comprises a housing, an antenna, and a rotating fastener. The housing comprises a receiving portion. The antenna is detachably disposed in the receiving portion and comprises a first buckling portion. The rotating fastener is pivoted to the housing and comprises a second buckling portion movably engaging the first buckling portion to fix the antenna to the housing.

The antenna comprises a substantially columned profile, and the receiving portion comprises a substantially columned space for receiving the antenna.

The antenna further comprises a rib. The receiving portion further comprises a guiding groove. The guiding groove is for the rib to slide therein when the antenna is not fixed to the housing.

The antenna and guiding groove extend along a central axis of the antenna.

The mobile communication device further comprises a pivot passing through the rotating fastener for pivoting the rotating fastener to the housing.

The mobile communication device further comprises a pivot integrally formed with the rotating fastener, by which the rotating fastener is pivoted to the housing.

The first buckling portion comprises a positioning hole. The second buckling portion comprises a protrusion. The antenna is fixed in the receiving portion when the protrusion is disposed in the positioning hole.

The antenna further comprises a curved segment on which the first engaging portion is disposed.

The rotating fastener further comprises a first engaging portion. The housing further comprises a second engaging portion. The first engaging portion engages the second engaging portion for fixing the rotating fastener to the housing.

The first engaging portion further comprises a resilient arm and a protruding element. The second engaging portion further comprises a recessed groove and a cavity. The rotating fastener is fixed to the housing when the resilient arm and protruding element respectively correspond to the recessed groove and cavity.

The mobile communication device further comprises a battery. The housing further comprises a recess in which the battery is disposed.

A detailed description is given in the following embodiments with reference to the accompanying drawings.

### DESCRIPTION OF THE DRAWINGS

The invention can be more fully understood by reading the subsequent detailed description in conjunction with the examples and references made to the accompanying drawings, wherein:

FIG. 1A is a schematic view of a conventional mobile communication device;

FIG. 1B is a schematic view of an antenna of a conventional mobile communication device;

FIG. 1C is a schematic view of another antenna of a conventional mobile communication device;

FIG. 2A is an exploded perspective view of the mobile communication device of the invention;

FIG. 2B is a schematic view of partial members of the mobile communication device of the invention;

FIG. 2C is a schematic view of the antenna of the mobile communication device of the invention;

FIG. 3A is a schematic view showing assembly of the mobile communication device of the invention;

FIG. 3B is a schematic view of the second engaging portion of the mobile communication device of the invention; and

FIG. 4 is another schematic view showing assembly of the mobile communication device of the invention.

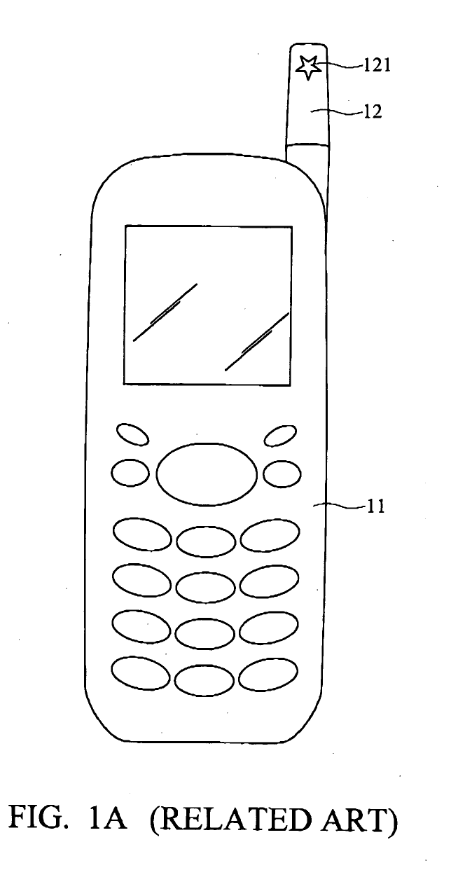

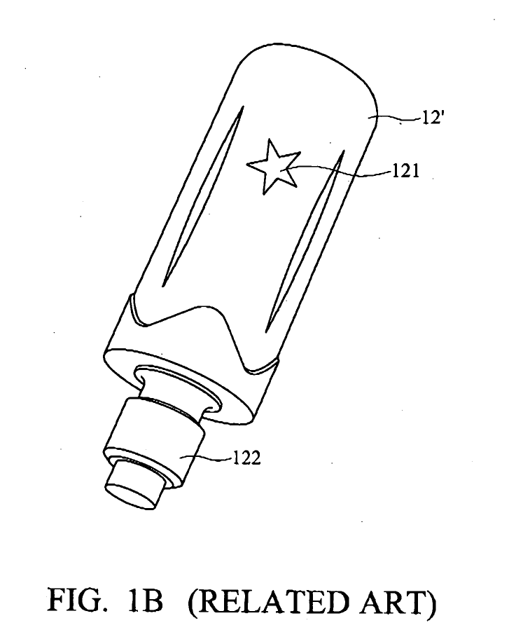

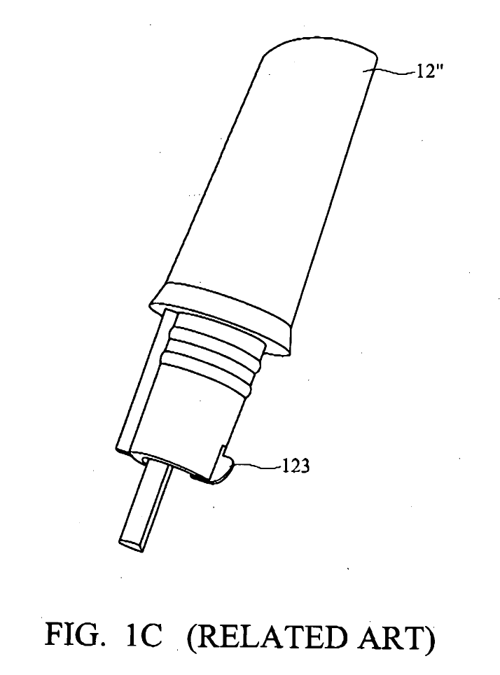

### DETAILED DESCRIPTION

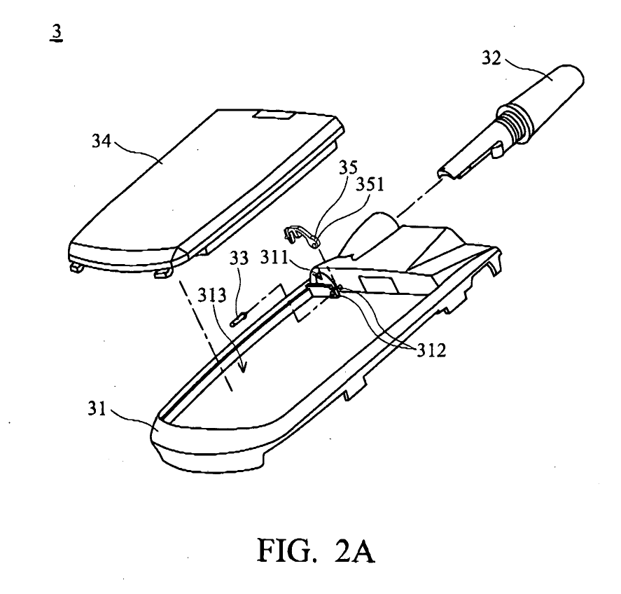

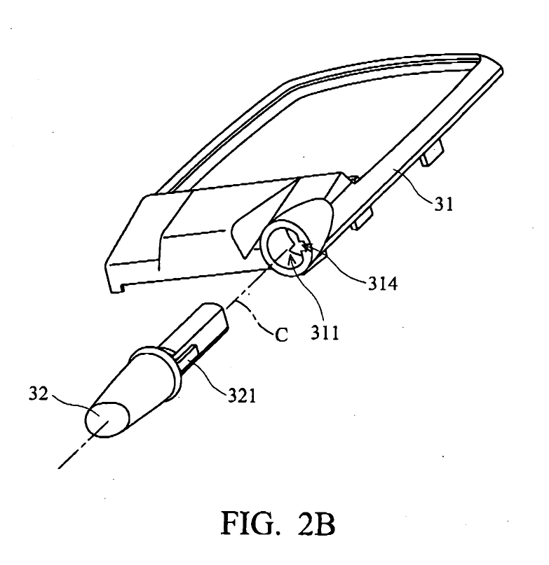

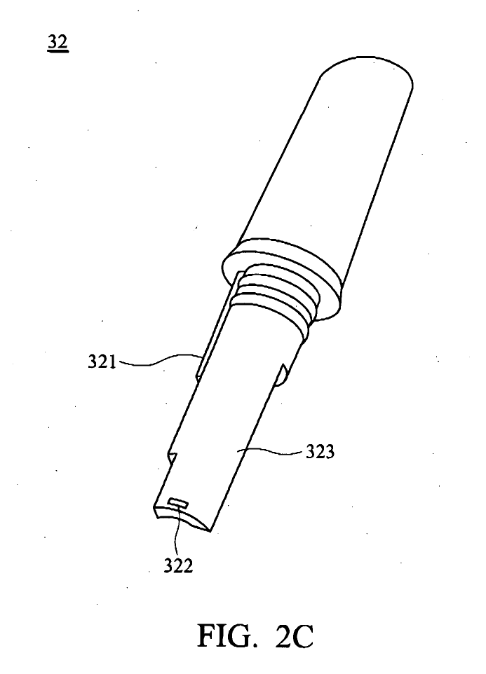

Referring to FIG. 2A, the mobile communication device 3 comprises a housing 31, an antenna 32, a pivot 33, a battery 34, and a rotating fastener 35. The antenna 32 comprises a substantially columned profile and is detachably connected to the housing 31. As shown in FIG. 2A, the housing 31 comprises a columned receiving portion 311 corresponding to and receiving the antenna 32. The battery 34 is disposed in a recess 313 formed on the central part of the housing 31. Additionally, a pivot hole 312 is formed in the housing 31. The pivot 33 is disposed in the pivot hole 312 and passes through a through hole 351 of the rotating fastener 35, such that the rotating fastener 35 is pivoted to the housing 31. Moreover, the pivot 33 may be integrally formed with the rotating fastener 35. Accordingly, the rotating fastener 35 is pivoted to the housing 31 by way of the pivot 33.

Referring to FIG. 2B, the columned antenna 32 comprises a strip-like rib 321 extending along a central axis C thereof. A guiding groove 314 corresponding to the rib 321 is formed on the inner surface of the receiving portion 311. The rib 321 can slide in the guiding groove 314, precisely positioning the antenna 32 in the receiving portion 311. Accordingly, as compared to the conventional mobile communication device, the present mobile communication device enables simplified replacement of the antenna 32. Additionally, when providing patterns or a specific profile, the antenna 32 can also be precisely positioned, matching the profile of the mobile communication device 3. Moreover, as shown in FIG. 2C, the antenna 32 comprises a curved segment 323 on which a first buckling portion 322 is disposed.

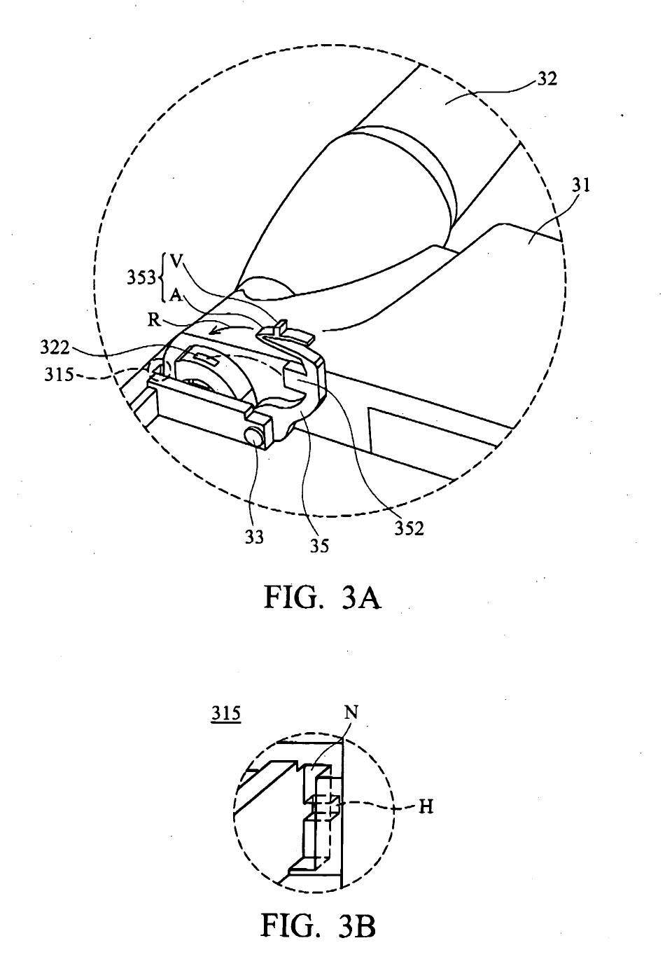

Referring to FIG. 3A, the antenna 32 is assembled to the housing 31 by inserting one end of the curved segment 323 into the receiving portion 311. At this point, the first buckling portion 322 is outside the receiving portion 311. The rotating fastener 35 then rotates in a direction shown by arrow R around the pivot 33. A second buckling portion 352 disposed on the central part of the rotating fastener 35 engages the first buckling portion 322, securely fixing the antenna 32 to the housing 31. In this embodiment, as shown in FIG. 3A, the first buckling portion 322 is a positioning hole while the second buckling portion 352 is a protrusion. The protrusion is inserted into the corresponding positioning hole, such that the antenna 32 and housing 31 are combined together and not loose.

A flexible first engaging portion 353 is disposed on one end of the rotating fastener 35. When the first buckling portion 322 and second buckling portion 352 are combined, the first engaging portion 353 engages a second engaging portion 315 in the housing 31. Specifically, as shown in FIG. 3A and FIG. 3B, the first engaging portion 353 comprises a resilient arm A and a protruding element V, and the second engaging portion 315 comprises a recessed groove N and a cavity H. When the first engaging portion 353 engages the second engaging portion 315, the resilient arm A and protruding element V slide into the recessed groove N. The protruding element V then enters the cavity H. At this point, the rotating fastener 35 is fixed to the housing 31.

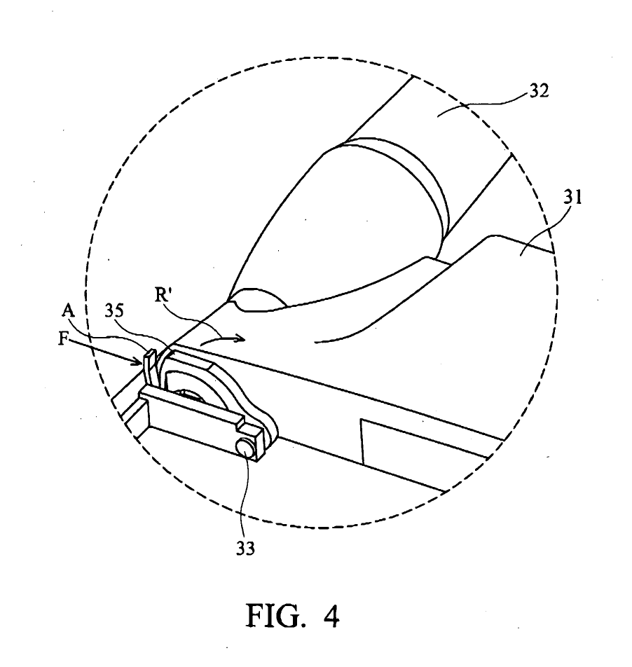

As shown in FIG. 4, the first engaging portion 353 is combined with the second engaging portion 315. By the rotating fastener 35 engaging the antenna 32 and housing 31, the antenna 32 is firmly combined with the housing 31 and not loosened therefrom. In another aspect, when the antenna 32 is removed from the housing 31, a force is applied to the resilient arm A of the rotating fastener 35 in a direction shown by arrow F, thereby separating the first engaging portion 353 of the rotating fastener 35 from the second engaging portion 315 of the housing 31. The rotating fastener 35 is then rotated in a direction shown by arrow R′ around the pivot 33, releasing the antenna 32. The antenna 32 is thus removed from the receiving portion 311 of the housing 31.

In conclusion, the disclosed mobile communication device allows the antenna to be easily fixed to the housing by means of the rotating fastener. The antenna can be positioned as required and easily replaced.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A mobile communication device, comprising:
a housing, with a receiving portion;
an antenna detachably disposed in the receiving portion and comprising a first buckling portion; and
a rotating fastener pivoted to the housing and comprising a second buckling portion movably engaging the first buckling portion to fix the antenna to the housing.

2. The mobile communication device as claimed in claim 1, wherein the antenna comprises a substantially columned profile, and the receiving portion comprises a substantially columned space for receiving the antenna.

3. The mobile communication device as claimed in claim 2, wherein the antenna further comprises a rib, the receiving portion further comprises a guiding groove, the guiding groove is for the rib to slide therein when the antenna is not fixed to the housing.

4. The mobile communication device as claimed in claim 3, wherein the antenna and guiding groove extend along a central axis of the antenna.

5. The mobile communication device as claimed in claim 1, further comprising a pivot passing through the rotating fastener for pivoting the rotating fastener to the housing.

6. The mobile communication device as claimed in claim 1, further comprising a pivot integrally formed with the rotating fastener, by which the rotating fastener is pivoted to the housing.

7. The mobile communication device as claimed in claim 1, wherein the first buckling portion comprises a positioning hole, the second buckling portion comprises a protrusion, and the antenna is fixed in the receiving portion when the protrusion is disposed in the positioning hole.

8. The mobile communication device as claimed in claim 1, wherein the antenna further comprises a curved segment on which the first buckling portion is disposed.

9. The mobile communication device as claimed in claim 1, wherein the rotating fastener further comprises a first engaging portion, the housing further comprises a second engaging portion, and the first engaging portion engages the second engaging portion for fixing the rotating fastener to the housing.

10. The mobile communication device as claimed in claim 9, wherein the first engaging portion further comprises a resilient arm and a protruding element, the second engaging portion further comprises a recessed groove and a cavity, and the rotating fastener is fixed to the housing when the resilient arm and protruding element respectively correspond to the recessed groove and cavity.

11. The mobile communication device as claimed in claim 1, further comprising a battery, wherein the housing further comprises a recess in which the battery is disposed.
